(19) United States
(12) Patent Application Publication
(10) Pub. No.: US 2026/0192901 A1
(43) Pub. Date: Jul. 9, 2026

(54) VISION-BASED SAFETY MONITORING ON MARINE VESSEL

(71) Applicant: MATRIX JVCO LTD trading as AIQ, Abu Dhabi (AE)

(72) Inventors: Youssef TAMAAZOUSTI, Abu Dhabi (AE); Dmitry EGOROV, Abu Dhabi (AE); Abdallah BENZINE, Abu Dhabi (AE); Suraj SHARAN, Abu Dhabi (AE); Umar ASIF, Abu Dhabi (AE); Javier VILLAFRUELA, Abu Dhabi (AE); Wael ALMADHOUN, Abu Dhabi (AE)

(73) Assignee: MATRIX JVCO LTD trading as AIQ, Abu Dhabi (AE)

(21) Appl. No.: 19/124,005

(22) PCT Filed: Oct. 28, 2022
(86) PCT No.: PCT/IB2022/060375

§ 371 Date: Apr. 24, 2025

(51) Int. Cl. B63C 9/00; G06T 7/194; G06T 7/73; G06V 10/25; G06V 40/10; G08B 21/08

(52) U.S. Cl. CPC B63C 9/0005; G06T 7/194; G06T 7/73; G06V 10/25; G06V 40/10; G08B 21/08; G06T 2207/10016; G06T 2207/10028; G06T 2207/20021; G06T 2207/30196

(57) ABSTRACT

The present invention relates to a computer-implemented method for determining a safety state of a marine vessel. The method comprises the steps of obtaining at least one video frame; detecting at least one person within the at least one video frame; determining, based on the detected person, a feature relating to a pose of the person; evaluating, based at least on the at least one feature, a safety state of the detected person; and determining the safety state of the marine vessel based at least on the safety state of the person. In addition, a corresponding computer program, a data-processing device and a marine vessel are disclosed.

### FIELD OF THE INVENTION

The present disclosure relates to a computer-implemented method, a data processing device/system and a computer program for determining safety states of marine vessels.

### BACKGROUND

Ensuring safe work conditions is essential for avoiding accidents at work. Accordingly, in the past, a lot of effort was put into improving work conditions and thus the safety of workers, of the environment and/or of machinery. Efficiently improving safety requires reliable and accurate measuring and monitoring of operation across time. This allows for a meaningful basis for identifying improvement potential (e.g., adjustment of the working area, like warning signs etc.). However, reliable and accurate safety monitoring is a challenging task. While known vision-based methods for safety monitoring, typically relying on the usage of cameras, achieve satisfying results under static conditions (i.e., in an environment like an indoor production facility), these methods struggle under dynamic conditions, where the environment is unknown and constantly changing. The latter is for example the case with marine vessels where the background in video images is constantly changing due to constantly changing weather conditions, heavy swell and so forth. As a result, image quality may vary greatly which renders it extremely challenging for the known vision-based methods to automatically perform monitoring in a reliable and accurate manner.

U.S. Pat. No. 10,372,976 discloses an object detection system for marine vessels including at least one image sensor positioned on the marine vessel and configured to capture an image of a marine environment. An artificial neural network trained to detect patterns within the image of the marine environment associated with one or more predefined objects receives the image as input and outputs detection information regarding a presence or absence of the one or more predefined objects. However, the approach provided therein ignores the problem of inter alia varying image quality and does thus not provide for a satisfying solution.

Against this background, there is a need for improving accuracy and reliability of methods for determining and/or monitoring a safety state on marine vessels.

### SUMMARY OF THE INVENTION

The above-mentioned problem is at least partly solved by a computer-implemented method, a data-processing device, a computer program and/or a data-processing system according to aspects of the present disclosure.

An aspect of the present invention refers to a computer-implemented method for determining a safety state of a marine vessel. The method may comprise the step of obtaining at least one video frame. The method may further comprise detecting at least one person within the at least one video frame. The method may further comprise determining based on the detected person a feature relating to a pose of the person. The method may further comprise evaluating based at least on the at least one feature a safety state of the detected person. The method may further comprise determining the safety state of the marine vessel based at least on the safety state of the person.

Considering information about a pose of the person for determining the safety state reduces the susceptibility of vision-based detection to varying image quality.

In another aspect, detecting the at least one person comprises: detecting the at least one person within a predetermined zoom-region of the at least one video frame.

Optionally, detecting the at least one person further comprises: determining a bounding box associated with a location of the at least one person within the predetermined zoom-region; and wherein determining the pose of the person comprises: estimating the pose based on the bounding box.

Providing a predetermined zoom-region increases the efficiency of the method, because a certain region of the video frame is first looked at and/or corresponding objects within the region are magnified. Providing information about the person/pose via a bounding box simplifies computation and processing of the information.

In yet another aspect, the method may further comprise determining based on the detected person a feature relating to a protection equipment associated with the person.

Optionally, determining the feature relating to the protection equipment comprises localizing at least one region of interest on the detected person based on the determined pose of the person; determining whether the at least one region of interest fulfills a corresponding safety requirement associated with the protection equipment.

Optionally, the at least one region of interest is a head of the at least one person; and the corresponding safety requirement is a helmet detection.

Optionally the at one least region of interest is an upper-body part of the at least one person; and the corresponding safety requirement is a life-vest detection.

Optionally the at least one region of interest is a full-body part of the at least one person; and the corresponding safety requirement is a uniform detection.

Optionally, evaluating the safety state of the detected person comprises setting the safety state of the detected person as not safe if the safety requirement is not fulfilled; or setting the safety state of the detected person as safe if the safety requirement is fulfilled.

Accuracy of localizing the region of interest is increased by using the pose. Thus, determining the safety state of the person is improved.

In yet another aspect, the method may further comprise determining a feature relating to a location of the detected person and/or pose within the videoframe.

Optionally, determining the feature relating to the location of the detected person and/or pose comprises: extracting a feet-joint from the determined pose of the at least one person; determining whether the feet-joint overlaps with a predetermined no-go region within the video frame.

Optionally, determining whether the feet-joint overlaps with the predetermined no-go region comprises: determining coordinates of the feet joint within the video frame; and determining whether the specified no-go region includes the determined coordinates of the feet joints.

Optionally, evaluating the safety of the detected person comprises: setting the safety state of the detected person as not safe if the feet-joint overlaps with the predetermined no-go region; or setting the safety state of the detected person as safe if the feet-joint does not overlap with the predetermined no-go region.

Extracting the foot-joint from the pose of the person and determining the location based thereon may increase the accuracy of determining whether the person is within a restricted area or not irrespective of the camera orientation.

Optionally, determining the feature relating to the location of the detected person and/or pose comprises: determining whether the detected pose of the at least one person is a standing pose or falling pose; and setting the safety state of the detected person as not safe if the detected pose is a falling pose; or setting the safety state of the detected person as safe if the detected pose is a standing pose.

Optionally, determining whether the detected pose is a standing or falling pose comprises: converting the pose into an abstraction of the pose; determining a reference abstraction for the abstraction of the pose; determining an angle between the reference abstraction and the abstraction of the pose; and wherein the pose is a falling pose if the angle is larger than a predefined angle threshold; or wherein the pose is a standing pose if the angle is smaller than or equal to the predefined angle threshold. Alternatively, the pose is a falling pose if the angle is larger than or equal to the predefined angle threshold or the pose is a standing pose if the angle is smaller than the predefined angle threshold.

Optionally, converting the pose into the abstraction of the pose comprises: determining a first principle segment based on a difference between a head-joint of the pose and a hips-joint of the pose; determining a second principle segment based on a difference between the hips-joint of the pose and a feet-joint of the pose; and wherein the first principle segment and the second principle segment represent the abstraction of the pose.

Optionally, determining the reference abstraction comprises: splitting the video frame into a first plurality of subframes; determining that a position of the pose is within one sub frame of the first plurality of subframes of the video frame; selecting the reference abstraction associated with the one subframe.

Optionally, the reference abstraction comprises: a third principle segment based on a difference between a head-joint of a reference pose and a hips-joint of the reference pose; a fourth principle segment based on a difference between the hips-joint of the reference pose and a feet-joint of the reference pose; and wherein the third principle segment and the fourth principle segment represent the reference abstraction.

Using and comparing an abstraction of the pose to a reference abstraction reduces computational effort and thus efficiency of a fall detection. Furthermore, the reference abstraction may encompass further information like environmental information (e.g., the corresponding vessel layout the camera is monitoring, the orientation and location of the camera etc.). This way, the efficiency of the method can be increased.

Optionally, determining the feature relating to the location of the detected person and/or pose comprises: determining whether the pose of the at least one person is within a predetermined man-overboard region; and setting the safety state of the detected person as not safe if the pose is within the predetermined man-overboard region; or setting the safety state of the detected person as safe if the pose is not within the predetermined man-overboard region.

Optionally, further comprising: obtaining a second video frame being prior to the at least one video frame; determining whether a person is detectable within a predetermined man-onboard region within the second video frame; wherein setting the safety state of the detected person further depends on the person being detectable within the predetermined man-onboard region or not.

Optionally, further comprising: determining that the person is detectable within the predetermined man-onboard region within the second video frame; determining that the pose of the detected person is within the predetermined man-overboard region within the one video frame; extracting movement information at least between the second video frame and the one video frame using background subtraction; determining whether the movement information relates to a fast movement or a slow movement; wherein setting the safety state of the detected person further depends on the movement information relating to a fast movement or a slow movement.

Optionally, the movement information is associated with the person detected within the predetermined man-onboard region and the pose within the predetermined man-overboard region.

Determining whether a person fell overboard based on the temporal comparison of the two video frames and/or the movement information increases robustness of the detection regarding false positive detection.

In yet another aspect, the method further comprises: determining an operation state of the marine vessel based at least on the at least one video frame; and wherein evaluating the safety state of the detected person is further based on the determined operation state of the marine vessel.

Optionally, determining the operation state comprises: splitting the at least one video frame into a second plurality of subframes; determining for each subframe of the second plurality of subframes of the video frame one operating condition classification resulting in a plurality of operating condition classifications; and determining the operating state based on the plurality of operating condition classifications.

Optionally, the operating state indicates whether the marine vessel is moving (e.g., sailing) or anchored.

Optionally, the operating condition classification indicates whether the subframe indicates sea or port.

Splitting the video frame into multiple subframes and classifying each subframe instead of the entire video frame at once, reduces complexity of the classification procedure. Thus, the operation state is not only determined faster due to the reduced complexity, but also more accurate, because the decision is democratized.

In yet another aspect, the method further comprises: issuing a safety notification based on the safety state of the marine vessel, wherein the safety state of the marine vessel indicates whether there is a safety issue on the marine vessel.

Optionally, issuing the safety notification is further based on temporal filtering.

Optionally, the at least one video frame is associated with one or more of vessel information, camera information, quality information, use-case information and/or operation information.

Optionally, the method further comprises: extracting from the one video frame and/or from at least one previous video frame information associated with the one video frame and/or the at least one previous video frame; and determining the vessel information, the camera information, the quality information, the use-case information and/or the operation information based on the extracted information.

Extracting and determining may be done automatically. This way, the corresponding information (vessel information, etc.) can be continuously updated.

Optionally, the predetermined zoom-region, the predetermined no-go region, the predetermined man-overboard region and/or the predetermined man-onboard region is based on at least one of the vessel information, camera information, quality information, use-case information and/or operation information.

Providing additional context information enables a more sophisticated decision than solutions solely based on information provided by a current video frame.

In yet another aspect, the method further comprises displaying the safety state of the marine vessel as a point cloud comprising a plurality of points wherein each point of the plurality of points is associated with a safety issue on the marine vessel and/or a safety state of a person on the marine vessel.

Based on the point cloud visualization, a comprehensive overview of past and/or present safety issues and/or safety states of persons on the marine vessel is provided.

Another aspect of the present invention relates to a data-processing device comprising means for performing the method as described above.

Another aspect of the present invention relates to a computer program comprising instructions, which when executed by a computer, causes the computer to perform the method as described above.

Another aspect of the present invention relates to a marine vessel comprising at least one camera and the data-processing device as described above.

### BRIEF DESCRIPTION OF THE DRAWINGS

Various aspects of the present invention are described in more detail in the following by reference to the accompanying figures without the present invention being limited to the embodiments of these figures.

FIG. 1 illustrates an exemplary overview of a method according to embodiments of the present invention.

FIG. 2 illustrates an exemplary first safety assessment procedure according to embodiments of the present invention.

FIG. 3a illustrates an exemplary second safety assessment procedure according to embodiments of the present invention.

FIG. 3b illustrates further exemplary details of the second safety assessment procedure according to embodiments of the present invention.

FIG. 3c illustrates further exemplary details of the second safety assessment procedure according to embodiments of the present invention.

FIG. 3d illustrates further exemplary details of the second safety assessment procedure according to embodiments of the present invention.

FIG. 4a illustrates an exemplary third safety assessment procedure according to embodiments of the present invention.

FIG. 4b illustrates further exemplary details of the third safety assessment procedure according to embodiments of the present invention.

FIG. 5 illustrates an exemplary fourth safety assessment procedure according to embodiments of the present invention.

FIG. 6 illustrates the exemplary determination of an operating state according to embodiments of the present invention

FIG. 7 illustrates an exemplary visualization receivable from the method according to embodiments of the present invention.

### DETAILED DESCRIPTION

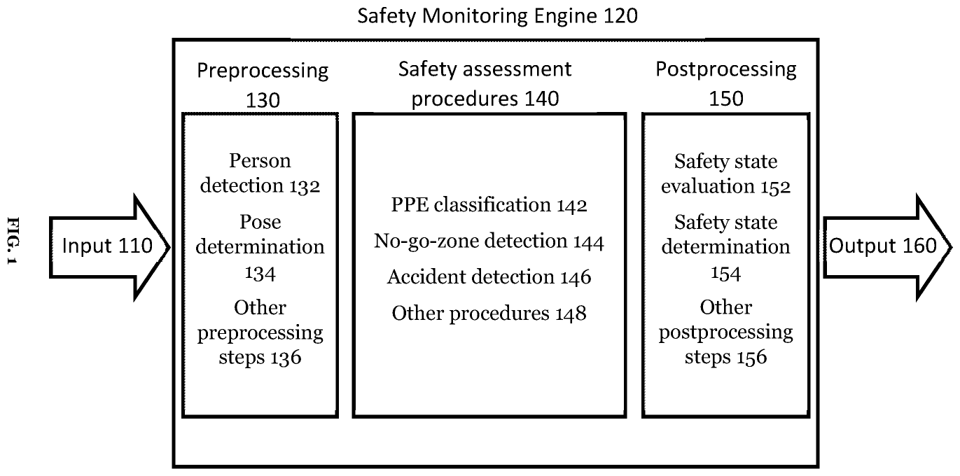

In the following, certain aspects of the present invention are described in more detail. FIG. 1 illustrates an exemplary overview of a method for determining a safety state of a marine vessel (e.g., a ship, a boat or an oil platform) according to aspects of the present invention.

Input 110 of the method may comprise obtaining at least one video frame, e.g., from a camera. The video frame may be recorded by a camera attached to the vessel and monitoring a corresponding section of the vessel. (e.g., a floor of the vessel next to a rail). The section of the vessel may correspond to the field of view of the corresponding camera. It may be possible that a plurality of cameras is attached to different sections of the vessel and that the safety state of the vessel is determined based on the input of the plurality of cameras. The method may be continuously executed (i.e., for each video frame) which may correspond to a real-time execution. The method may also be executed on demand (i.e., only for the video frame of the demanded time point).

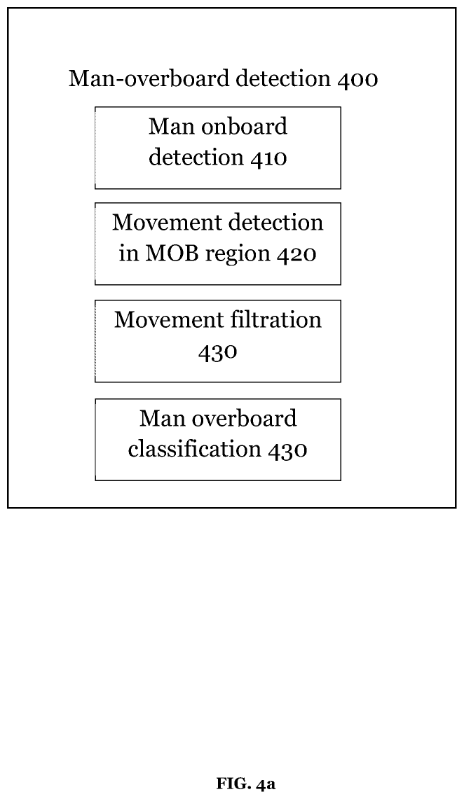

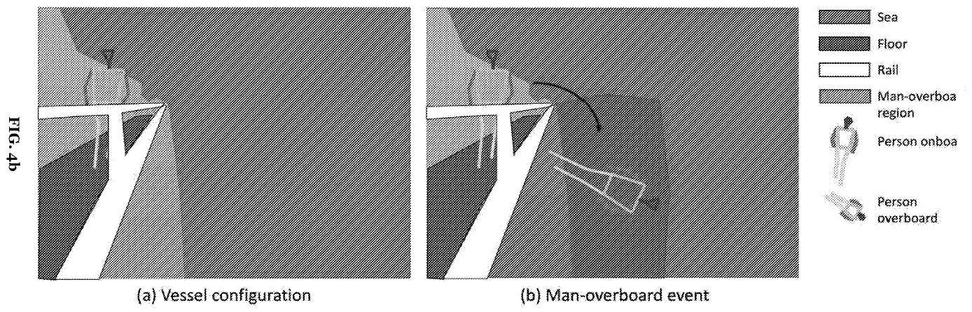

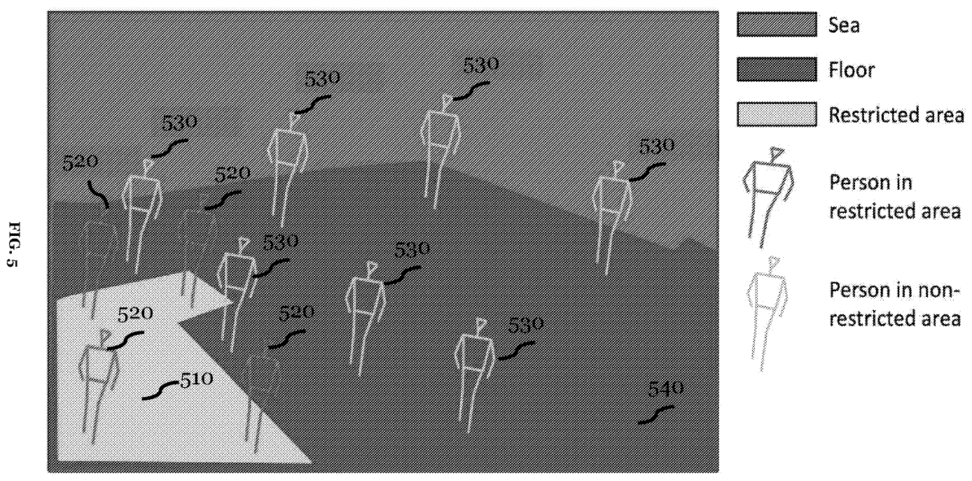

The input 110 may in addition comprise one or more of the following information.
Vessel information providing information about the location of the vessel, floors of the vessel, deck rails of the vessel, stair boundaries or other components. The vessel information may be indicated using polygons or binary masks of the corresponding part of the vessel as further explained with respect to FIGS. 4 and 5.
Camera information providing zooming information and/or camera mode information. Zooming information may include a zoom-region (e.g., zooming bounding box coordinates) and/or a warmup map (i.e., a map of all possible locations and/or poses of a person within the video frame). This may be helpful in case of the camera monitoring a large field of view so that the detection may be accelerated. The warmup map may be represented as a pixel-based mask. The warmup map may be within the zoom-region. The zoom-region may be predetermined. Predetermined as used within the present disclosure may relate to predefined, annotated prior to usage or dynamically determined (e.g., by extracting associated information) using detection models or algorithms. Camera mode information may include a RGB (color) or IR (infra-red) information (e.g., a flag indicating whether the video frame was recorded using RGB or IR). RGB may be used during day while IR may be used during night.
Quality information providing information about the quality of each pixel of the video frame for example via a corresponding image-quality map (e.g., pixel-based mask). Quality criteria may be illumination (i.e., a corresponding dark-light map may be provided) and/or weather conditions, like foggy, rainy etc. (i.e., a corresponding weather map may be provided). A value of each pixel of the corresponding map may be either continuous or binary.
Use-case information providing additional information, like information about restricted areas on the vessel (e.g., a no-go region representing a binary mask that marks all the pixels of the video frame where persons cannot be present), man-overboard and/or man-onboard regions, sea-, seaport-, and port masks, and/or a set of reference abstractions.
Operation information providing information relating to an operation state of the vessel (e.g., whether the vessel is moving/sailing or anchored) and/or dependencies between the operation state of the vessel and the safety state (e.g., a region may be a no-go region only if the vessel is moving). Accordingly, the safety state of the vessel may not be negatively affected (e.g., issuing a safety notification indicating that there is a safety issue on the marine vessel) even if a person is detected in such a no-go region, if the vessel is anchored. The operation information may be used for filtering operations.

The input 110 may be fed into a safety monitoring engine 120. Afterwards in step 130, more preprocessing 130 steps on the input 110 may be conducted. These steps may be (partially) executed sequentially and/or in parallel.

In step 132, at least one person within the at least one video frame is detected. Detecting the at least one person may be within a predetermined zoom-region of the at least one video frame. Detecting the at least one person may further comprise determining a bounding box associated with a location of the detected person within the video frame and/or within the predetermined zoom-region. Accordingly, a list of bounding boxes may be generated. The person detection 132 may be done using a pre-trained detection model which is then fine-tuned to the present use case of marine vessels. This fine-tuning is required due to the uniqueness of marine vessels. For example, many parts of the vessel might have similar shapes as a person (e.g., pipes, posts or ropes). As a result, a pre-trained model without fine-tuning will likely wrongly detect persons due to the domain shift. In addition, the pre-trained models are often trained to detect persons of certain pixel sizes. Accordingly, a camera with unusual image settings (e.g., large field of view etc.) may create video frames of unusual pixel scales. Therefore, fine-tuning these pretrained models are required to increase the detection quality and thus the quality of safety determination. In a first example, the fine-tuning may comprise a zooming module which may take the video frame and associated camera information, like zooming information, as input. The video frame in original resolution may be cropped according to the zooming information (e.g., the zooming bounding box coordinates). Person detection 132 may then only be performed on the cropped snapshot of the video frame, which increases recall of the person detection 132. A resulting bounding box associated with the location of the person may then be reprojected into the video frame of original resolution.

In a second example, the fine-tuning may in addition or alternatively comprise a detection verification. This way a wrong detection (i.e., a person is detected within the video frame even though no person is present) can be recognized and avoided. This may be done by using a different person classifier model taking as input the bounding box of the allegedly detected person and outputting a classification (i.e., person or no person). A person classification within the video frame by a different classifier may be an indication of a person being within the video frame. Additionally, or alternatively, verification may be done by checking the presence of movement within the bounding box (e.g., based on pixel intensity between the video frame and a second video frame prior to the video frame). A movement may be an indication for a person being within the video frame. Additionally, or alternatively, verification may be done by comparing the bounding box (e.g., the size with respect to height) to information provided by a warmup-map. If the bounding box size was commonly detected according to the warmup-map, this may be an indication for a person being within the video frame.

In step 134, a pose of the detected person may be determined. Determining the pose of the detected person may be based on the bounding box determined in step 132. The pose determination 134 may be done by estimating the pose based on the bounding box.

In step 136, other preprocessing steps may be conducted in addition, like determining extracting, or collecting one of the additional information of the input 110. For example, the zooming information, if not manually predefined, can be determined using a corresponding model. The model may take video frame(s) as input and detect regions of activity within the video frame during a certain time window. These regions may serve as zooming information. In another example, the warmup map may be determined using a similar model, which not only detects the activities but also corresponding postures of persons associated with the activities. These insights may be stored (e.g., into a data base) and sorted according to their corresponding region within the video frames (e.g., a video frame recorded by the corresponding camera may be split into a grid of cells, wherein each cell represents a region). The stored data may further be used as reference for other methods or procedures explained within this disclosure.

In another example, the camera mode information, if not predefined manually, may be determined based on the video frame using a vision algorithm which determines whether the video frame is in RGB or IR. This may for example be done by checking the average of the pixel channels. If they are the same, this is an indication for an IR mode. The vessel information (e.g., a mask indicating the components of the vessel within the video frame), if not predefined, may also be determined using a vision model suitable for semantic segmentation. Similar approaches may be conducted with respect to the quality information. For example, a corresponding model may determine for each pixel of the video frame a value with respect to illumination (i.e., a dark-map will be generated) or with respect to weather conditions (i.e., a weather map will be generated).

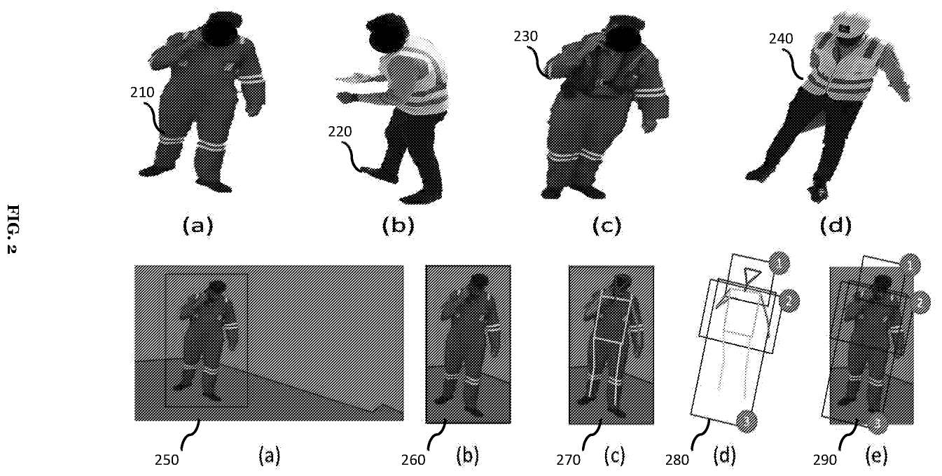

The preprocessed input is then used for one or more safety assessment procedures 140, which determine one or more features based on the preprocessed input (i.e., at least the detected person). The exemplary safety assessment procedures personal protection equipment (PPE) classification 142, no-go zone detection 144, accident detection 146 (e.g., slip and fall detection or man-overboard detection) or other procedures 148 (e.g., determining an operation state of the marine vessel) are explained with respect to the FIGS. 2 to 6.

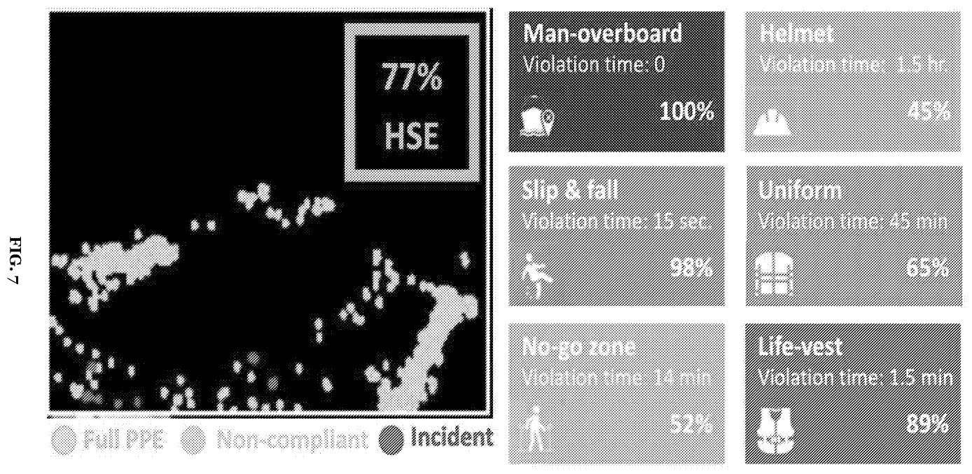

The output of the one or more safety assessment procedures 140 (e.g., the determined on or more features) are used for postprocessing 150. Postprocessing 150 may comprises evaluating 152 based on the one or more features a safety state of the detected person. The safety state of the marine vessel may indicate whether there is a safety issue on the marine vessel or not. Postprocessing 150 may also comprise determining the safety state of the marine vessel 154 based at least on the safety state of the person. Postprocessing 150 may also comprise other postprocessing steps 156, like filtering operations (e.g., temporal or operation based) or analytics (e.g., safety statistics) used for corresponding visualizations (see for example FIG. 7).

Temporal based filtering operations may be used to avoid issuing safety notifications unnecessary often. For example, if a person is within a no-go zone for a plurality of consecutive video frames, the safety state of the person would be determined as unsafe for each video frame of the plurality of video frames. Thus, for each video frame a safety notification would be issued. This may be avoided by applying temporal filtering. A time-window may be defined during which no further safety issue notification for the same detected safety issue will be issued. Determining that the same person causes the safety issue may be done by tracking the person and grouping the safety issues into an event group (e.g., no-go zone event, man overboard vent, falling person event etc.) and only issuing one safety notification per event group.

Operation based filtering operation may be used to avoid issuing inappropriate safety notifications. Based on the determined operation state results of the safety state determination resulting in a safety notification may be disabled. For example, if a person was detected in a region, which is restricted when the vessel is moving, this would result in a safety notification being issued. However, if the operation state of the marine vessel is determined to be anchored, the corresponding region may no longer be restricted. As a result, the safety notification may be disabled (i.e., not being issued).

After postprocessing, output 160 may be generated. The output 160 may comprise issuing a safety notification based on the safety state of the marine vessel and/or other results of the postprocessing 150 (e.g., analytics results).

FIG. 2 illustrates a PPE classification 142 according to aspects of the present invention. The goal of this procedure is to determine whether certain safety requirements are fulfilled. The safety requirements may relate to personal protective equipment (PPE) like helmets, life-vest, uniforms workers have to wear as a first line of defense in case of an incident etc. It is to be understood that the procedure explained in the following may also be applied to other types of PPE or the like.

The top part of FIG. 2 illustrates exemplary use cases for a PPE classification 142. For example, person 210 is wearing a uniform, but no life-vest, person 220 is without any PPE, person 230 is wearing uniform and a life-vest, but no helmet, or person 240 is not wearing a uniform and life-vest, but a helmet. In an example, this may be achieved using an artificial intelligence model like a convolutional neural network (CNN). The architecture of the CNN may be based on ImageNet, AlexNet, VGG-Net, RestNet or the like. The CNN may be pre-trained and adapted (i.e., fine-tuned) to the corresponding use case (e.g., helmet classification, life-vest classification, uniform classification). There may be one CCN for each of these use cases to overcome the challenge of a large plurality of combinations of people not fulfilling safety requirements as shown in the top part of FIG. 2. In order to cover the data space as good as possible and an optimal training data (e.g., well annotated video frames) set enabling the model(s) to handle the large diversity with respect to background, different types of vessels and different camera recordings is necessary. This may be achieved using a fast annotation process. First, a you-only-look-once (YOLO) detector is run on each available video frame extracting bounding boxes of persons. Movement of detected persons are tracked using a simple online real-time tracking (SORT) algorithm. Detecting and tracking a person within a plurality of sequential video frames may result in a person tubelet. A tubelet may refer to a sequence (e.g., with respect to the bounding box) of the same object (e.g., a person) within a plurality of sequential video frames (e.g., a video stream). As a result, not each video frame has to be annotated, but only a tubelet.

The task to be solved with respect to determining whether certain safety requirements are fulfilled (e.g., PPE) can be described as a binary classification task in which detection of the corresponding PPE are positive events and detection of no PPE (i.e., label indicating e.g., “no helmet”, “no uniform”, “no live-vest” etc.) are negative events. The output of the classification may be binary (i.e., 0 or 1) or a probability for each label (e.g., a first probability for “helmet” and a second probability for “no-helmet). The latter may be achieved using a Softmax Cross-Entropy loss function during training and a corresponding threshold may be determined defining a minimum probability for a negative event classification.

The bottom part of FIG. 2 illustrates a method of overcoming this challenge according to aspects of the present disclosure. The input of the method may be preprocessed as described with respect to the preprocessing 130 step of FIG. 1. The pictures according to steps 250-270 of FIG. 2 exemplarily illustrate the preprocessing 130 with respect to the PPE classification 142. As one can see in step 250, a person is detected within the video frame and a bounding box associated with the location of the person is determined (e.g., within a predetermined zoom-region as explained with respect to preprocessing 130 of FIG. 1). Step 260 illustrates a cropped part of the video frame according to the detected person (e.g., based on the determined bounding box). In step 270, a pose of the person is determined (e.g., by estimating the pose based on the bounding box). The input of the method may further comprise information as explained with respect to input 110 (e.g., camera information such as zoom-region or warmup-map or quality information such as an image-quality map). As a result, the method is able to deal with input video frames of different kinds (e.g., day and night, multiple weather conditions and backgrounds etc.). This way, robustness in terms of classification is increased and thus the accuracy of determining the safety states.

In step 280, at least one region of interest on the detected person based on the determined pose of the person is localized as illustrated by the enumerated video frame parts (1, 2 and 3) of 280. The at least one region may be any one of a head, a full-body part or an upper-body part of the detected person. Other regions (e.g., legs etc.) may be possible. A region of interest may be determined in form of a bounding box. Using the pose as basis for locating the corresponding region of interest has the advantage of higher detection accuracy, because potential influence of a complex background on the detection is avoided. As a result, the region of interest (e.g., head part 1, upper-body part 2 or fully body part 3) may be located reasonably within the video frame as illustrated in step 290.

In step 290, it is determined whether the at least one region of interest fulfills a corresponding safety requirement associated with the protection equipment. For example, in case of a head being the region of interest, a head detection, in case of an upper-body part being the region of interest, a life-vest detection, or in case of a full-body part being the region of interest, a uniform detection may be used. If one of the safety requirements is not fulfilled, evaluating the safety state of the detected person 152 may comprise setting the safety state of the detected person as not safe. If the safety requirement(s) are fulfilled, the safety state of the detected person may be set as safe. Each of the corresponding video frame parts (i.e., head 1, upper body 2 or full body 3) may be used as an independent input to the corresponding model (e.g., the model specifically trained for the helmet classification receives as input the video frame part including the head, the model specifically trained for the life-vest classification receives as input the part including the upper-body and/or the model specifically trained for the uniform classification receives as input the part including the full body). It may be possible that the video frame parts are preprocessed before being fed into the corresponding model (e.g., standardized regarding size or rotation). It may be possible that the video frame parts are evaluated regarding quality before being fed into the corresponding model.

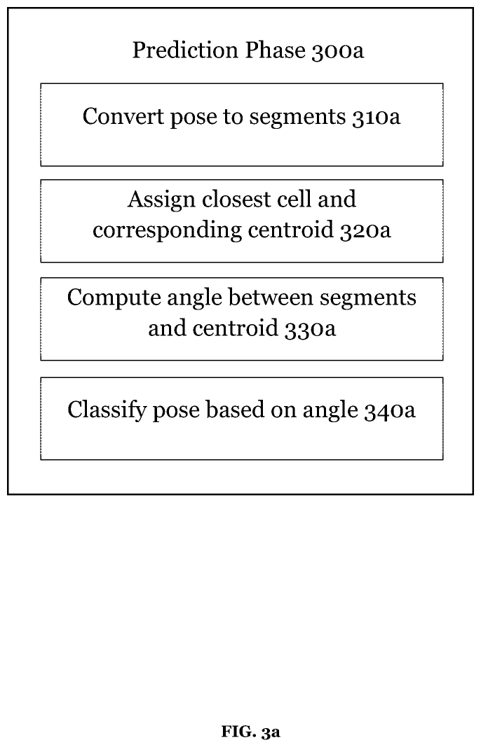

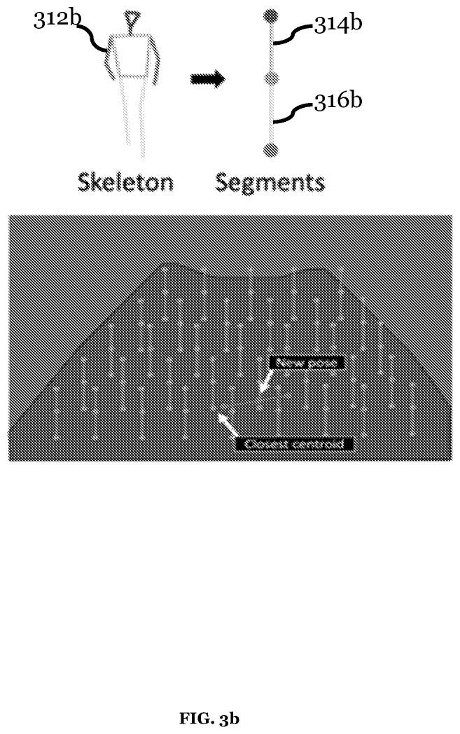

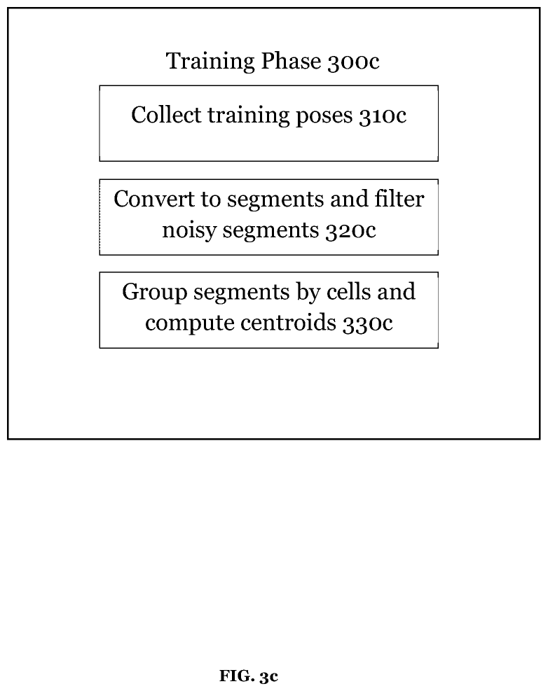

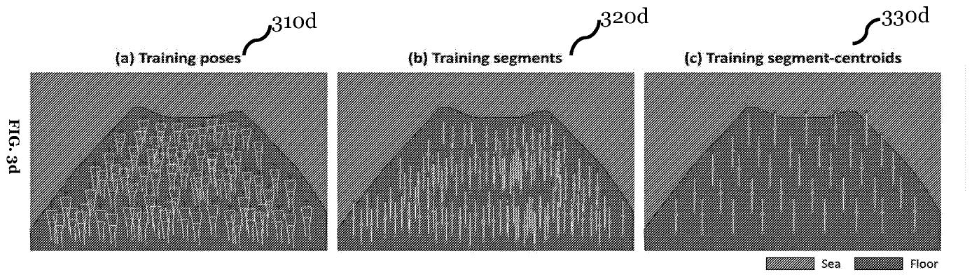

FIGS. 3a and 3b illustrate an accident detection 146, namely a slip and fall detection. The goal of this procedure is to determine whether a person has slipped or fallen, for example due to the vessels'swell level being high and thus the risk for a fall event being higher than in a static place, like a factory. A high swell level may be the case if the vessel is moving.

In general, this may be achieved by determining whether the pose of the detected person is a standing pose or falling pose. The problem may thus be described as a classification task of the pose into standing or falling. In case the pose is a standing pose the safety state of the detected person may be set as safe. In case the pose is a falling pose, the safety state of the detected person may be set as not safe.

FIGS. 3a and 3b illustrate an example of a prediction phase 300a detecting a slip and fall event. The prediction phase 300a may be executed using a model trained according to a training phase explained with respect to FIGS. 3c-d. In order to determine whether the detected pose 312b is a standing pose or falling pose, the following steps may be conducted.

In step 310a, the pose 312b is converted into an abstraction of the pose. Converting the pose 312b into the abstraction of the pose may comprise determining a first principle segment 314b based on a difference (e.g., based on coordinates) between a head-joint of the pose 312b and a hips-joint of the pose 312b and a second principle segment 316b based on a difference between the hips-joint of the pose 312b and a feet-joint of the pose 312b.

In step 320a, a reference abstraction for the abstraction of the pose 312b is determined. The reference abstraction may also comprise two principle components (third and fourth) similar to the abstraction of the pose 312b. Determining the reference abstraction may comprise splitting (e.g., according to a grid of the video frame comprising n×m cells) the video frame into a first plurality of subframes (e.g., referred to as a cell), assign the closest subframe/cell and select the reference abstraction associated with the closest subframe/cell. Assigning may be done bay determining that a position of the pose 312b is within the corresponding subframe/cell of the first plurality of subframes/cells of the video frame. The reference abstraction may be a centroid abstraction determined as illustrated in FIGS. 3c-d.

In step 330a, an angle between the reference abstraction and the abstraction of the pose 312b is determined. For example, the angle may be computed based on the principle components of both, the reference abstraction and the abstraction of the pose 312b.

In step 340, the pose is classified as either a falling pose or standing pose based on the angle. For example, if the angle is larger than a predefined angle threshold (e.g., 45°) the pose is a falling pose and if smaller than or equal to the predefined angle threshold the pose is a standing pose.

The advantage of this anomaly detection-based approach compared to a generic model trained to detect fall events is that the potential impact of data set imbalances (e.g., a person standing is most likely more often recorded as a person falling) is avoided. Thus, the detection using the presented model is more accurate. It may be possible that for each camera installed on the vessel, a corresponding slip and fall model is developed and deployed in order to overcome challenges related to different camera orientations, the different regions of the vessel monitored etc.

FIG. 3c and FIG. 3d illustrates a training phase 300c for a model performing the slip and fall detection as explained with respect to FIGS. 3a-b. The aim of the training phase 300c is to generate a model, which takes as input a pose and determines, using an anomaly detection approach, whether the pose is standing (i.e., the normal case) or falling (i.e., the unnormal case). Such a model may be trained for each camera (i.e., one specific type of video frame with respect to orientation, monitored scene etc.) on the vessel.

In step 310c, training poses 310d are collected. The training poses 310d may be generated using the person detection and pose determination as explained within this disclosure.

In step 320c, the collected training poses 310d are converted to segments 320d. Noisy segments (e.g., segments where the converting was erroneous) may be filtered (i.e., removed). Using the segments 320d instead of the poses 310d reduces the diversity amount of poses and thus the required amount of training data. As a result, the feature space is significantly reduced resulting in faster execution time of the prediction phase 300a.

In step 330c, the segments 320d generated in step 320c are grouped according to the position within the video frame. For example, the video frame may be split into a plurality of subframes/cells. The segments within the same subframe may form a group. This way potential impact of image perspective is avoided. For example, if a person A is in the bottom left corner and person B in the top-right corner of the camera view, the sizes and poses of person A and B may be completely different. This may have a negative effect on the training results. Therefore, the video frame is split into cells and the segments 320d are grouped accordingly ensuring that only similar poses are compared. For each group of segments, a centroid 330d is computed. Using the centroid 330d as reference abstraction and thus for classifying the pose, instead of all segments of the group, improves the computational efficiency. The centroid may be computed using unsupervised learning techniques (e.g., clustering). During prediction phase 300a, the centroid closest to the detected pose or the respective segments may be selected as reference abstraction. The closest centroid may be determined using the K-Nearest-neighbors algorithm, wherein the distance between the detected pose and the centroid of the cell is computed. The centroid having the smallest distance is selected as the closest centroid.

FIGS. 4a-b illustrate another accident detection 146, namely a man-overboard detection 400. The goal of this procedure is to determine whether as person has gone overboard. The problem to be solved may be considered as a person detection task within a certain (e.g., predetermined) man-overboard (MOB) region. Another approach would be detecting a person, tracking the person and detect whenever the person crosses a certain line of danger (e.g., a rail). The advantage of the first approach compared to the latter one is less required computational resources.

The problem may be solved by determining whether the pose of the at least one detected person is within a predetermined MOB region (man overboard classification 430). If the pose is within the predetermined man-overboard region the safety state of the detected person may be set as not safe. If the pose is not within the predetermined man-overboard region the safety state of the detected person may be set as safe. Detecting a person within the predetermined MOB region may be difficult due abnormal poses (e.g., caused by falling over the rail) and/or an uncommon sea background. Therefore, the method may further comprises obtaining a second video frame being prior to the at least one video frame, determining whether a person is detectable within a predetermined man-onboard region within the second video frame (man onboard detection 410). Setting the safety state of the detected person may then further depend on whether the person was detectable within the predetermined man-onboard region (or not) within the second video frame. The idea is that if no person was in a man-onboard region in a previous video frame (e.g., the person standing within the floor area in the left part of FIG. 4), the probability of a person being within a corresponding MOB region in a subsequent video frame is very low. This way, prediction robustness of the method is increased.

However, it may still be possible that a slow movement blob within the MOB region (e.g., a wave or a person walking through the MOB region while the vessel is anchored, a truck refilling fuel of the vessel while the vessel is anchored) was mistakenly detected and classified as a person due to the above-mentioned possibly abnormal poses of a falling person. Therefore, the method may further comprise determining that the person is detectable within the predetermined man-onboard region within the second video frame (man onboard detection 410) and determining that the pose of the detected person is within the predetermined man-overboard region within the one video frame (movement detection in MOB region 420). Movement information at least between the second and the one video frame may be extracted (e.g., using background subtraction) and it may be determined whether the movement information relates to a fast movement or slow movement (movement filtration 430). The movement information may also be extracted between a plurality of video frames (previous to the one video frame and/or after the one video frame). Setting the safety state of the detected person may then further depend on the movement information relating to a fast movement or slow movement. The movement information may be associated with the person detected within the predetermined man-onboard region and the pose within the predetermined man-overboard region. This way, non-significant moving blobs (i.e., slow movements) can be filtered out. and only fast movements, like a falling person will be considered. As a result, the prediction robustness of the method is increased.

FIG. 5 illustrates a no-go-zone detection 144 according to aspects of the present invention. The goal of this procedure is to determine whether a person is within a no-go zone 510 on the vessel. This may be achieved by extracting a feet-joint from the determined pose of the at least one detected person and determine whether the foot-joint overlaps with a predetermined no-go region within the video frame. Determining whether the feet-joint overlaps with the predetermined no-go region may comprise determining coordinates of the feet-joint within the video frame and determining whether the predetermined no-go region includes the determined coordinates of the feet joints. If yes, the safety state of the detected person would be set as not safe 520. If not, the safety state of the detected person would be set as safe. The predetermined no-go region within the video frame may vary depending on an operation state of the marine vessel. For example, during movement (e.g., sailing) a certain region may be a no-go region, while during stay (e.g., anchored) the certain region may no longer be a no-go region.

In the example illustrated in FIG. 5 a part of a vessel is shown comprising a floor region, sear and a restricted area 510. While staying in the floor region 540 is allowed, staying within the restricted area 510 (i.e., the no-go zone) is not allowed. In this example, the safety state of the seven detected persons 530 within the floor region 540 would be safe, while the safety state of the four detected persons 520 within the restricted area 510 would be unsafe. Accordingly, a safety notification may be issued based on the (unsafe) safety state of the marine vessel indicating that there is a safety issue on the marine vessel, namely the four persons being within a no-go-region. However, this notification may be filtered (i.e., suppressed/not issued) depending on the operating state of the marine vessel.

Using the feet-joint instead of for example the head-joint has the advantage of higher accuracy of detection. This can be seen, as three out of the four persons 520 within the restricted area 510 would not have been detected if taken their head-joint, because their respective head-joint (i.e., the corresponding pixels) are not within the restricted area 510. Depending on the camera orientation other pose-joint (e.g., head etc.) may used for no-go-zone detection.

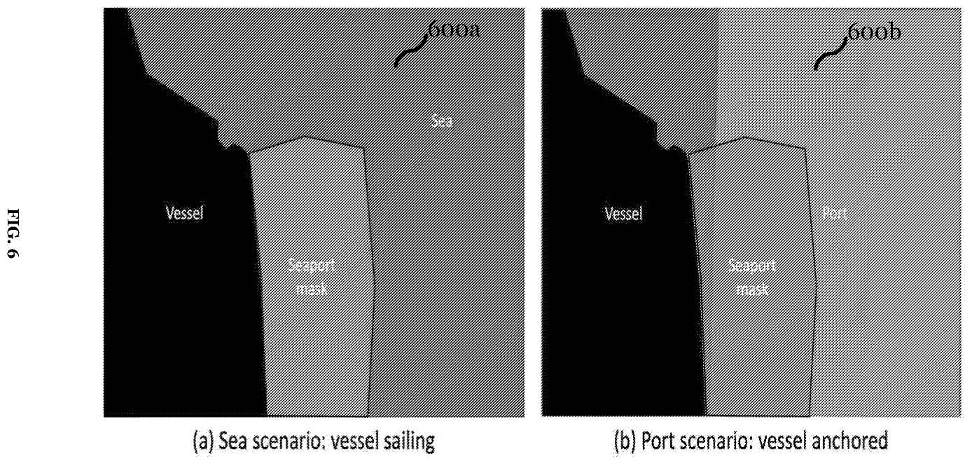

FIG. 6 illustrates an example for a procedure 148, namely determining an operation state of the marine vessel. The left part of FIG. 6 shows a sea scenario 600a, in which the operation state of the marine vessel would be determined as moving (e.g., sailing). The right part of FIG. 6 shows a port scenario 600b, in which the operation state of the marine vessel would be determined as anchored. Determining the operation state of the marine vessel may be based at least on the at least one video frame. The methods explained with respect to postprocessing 150 may be based on the determined operation state of the marine vessel. Determining the operation state may comprise splitting the at least one video frame into a second plurality of subframes, determining for each subframe of the second plurality of subframes of the one video frame an operating condition classification resulting in a plurality of operating condition classifications and determining the operating state based on the plurality of operating condition classifications. The operating state may indicate whether the marine vessel is moving (e.g., sailing) or static (e.g., anchored). The operating condition classification may indicate whether the subframe indicates sea or port. Determining the operating condition classification of a subframe may be done using a convolutional neural network. The network may be trained by fine-tuning a pretrained model like ImageNet. In this example, fine-tuning may comprise training the model on patches (i.e., subframes) indicating either sea or port. The corresponding labels may be determined by extracting the information using semi-automatically annotated sea masks or (sea-)port masks. Determining the operation state of the marine vessel based on the plurality of operating condition classifications may comprise determining that a number of operating condition classifications indicating sea is (equal to or) larger than a predetermined threshold and setting the operation state of the marine vessel as moving (e.g., sailing). If it is determined that the number of operating condition classification indicating sea is (equal to or) smaller than the predetermined threshold, the operations state of the marine vessel may be set as static (e.g., anchored). It may also be possible that the operation state is classified using a convolutional neural network which determines the operation state using the (whole) video frame as input (i.e., end-to-end approach).

FIG. 7 illustrates an exemplary visualization resulting from the method according to aspects of the present invention. FIG. 7 shows a point cloud of detected safety issues on a marine vessel. The point cloud may comprise a plurality of points wherein each point is associated with an identified safety issue on the marine vessel. The visualization may be a result of postprocessing steps 156 like analytics (e.g., safety statistics) used for the corresponding visualizations (e.g., birds-eye view of the vessel). The result may be collected from one or more vessels (e.g., of the same construction type) and transmitted to a central health safety and environment (HSE) platform, where the results may be validated and used to identify locations on the vessel with safety improvement potential or to identify best practices which avoid incidents. Identifying may be based on the safety statistics indicating a ratio between dangerous events (e.g., a detected person not wearing helmet etc.) and non-dangerous events (e.g., a person wearing a helmet). The ratio may be determined for each type of event (e.g., PPE classification 142, no go zone detection 144, accident detection 146). The ratio may be determined using the absolute amount of corresponding event types or a time duration of the events. For example, if four non-helmet events were detected and 6 helmet events were detected, the ratio may be 40%. Visualization (e.g., color code) may be adjusted according to the ratio (e.g., red for a high percentage and green for a low percentage). The ratio may be determined for a predetermined time window. Furthermore, the results may be used for improving the methods (e.g., models used within the present disclosure may be retrained using the newly available data). For example, feedback associated with the detected safety issues may be collected and used for retraining (i.e., the feedback may be associated with the respective video frame and used as a label).

The aspects according to the present invention may be implemented in terms of a computer program which may be executed on any suitable data processing device comprising means (e.g., a memory and one or more processors operatively coupled to the memory) being configured accordingly. The computer program may be stored as computer-executable instructions on a non-transitory computer-readable medium.

Embodiments of the present disclosure may be realized in any of various forms. For example, in some embodiments, the present invention may be realized as a computer-implemented method, a computer-readable memory medium, or a computer system. The steps described within this disclosure may be automatically performed.

In some embodiments, a non-transitory computer-readable memory medium may be configured so that it stores program instructions and/or data, where the program instructions, if executed by a computer system, cause the computer system to perform a method, e.g., any of the method embodiments described herein, or, any combination of the method embodiments described herein, or, any subset of any of the method embodiments described herein, or, any combination of such subsets.

In some embodiments, a computing device may be configured to include a processor (or a set of processors) and a memory medium, where the memory medium stores program instructions, where the processor is configured to read and execute the program instructions from the memory medium, where the program instructions are executable to implement any of the various method embodiments described herein (or, any combination of the method embodiments described herein, or, any subset of any of the method embodiments described herein, or, any combination of such subsets). The device may be realized in any of various forms.

Although specific embodiments have been described above, these embodiments are not intended to limit the scope of the present disclosure, even where only a single embodiment is described with respect to a particular feature. Examples of features provided in the disclosure are intended to be illustrative rather than restrictive unless stated otherwise. The above description is intended to cover such alternatives, modifications, and equivalents as would be apparent to a person skilled in the art having the benefit of this disclosure.

The scope of the present disclosure includes any feature or combination of features disclosed herein (either explicitly or implicitly), or any generalization thereof, whether or not it mitigates any or all of the problems addressed herein. In particular, with reference to the appended claims, features from dependent claims may be combined with those of the independent claims and features from respective independent claims may be combined in any appropriate manner and not merely in the specific combinations enumerated in the appended claims.

1. A computer-implemented method for determining a safety state of a marine vessel, the method comprising the steps of:
obtaining at least one video frame;
detecting at least one person within the at least one video frame;
determining, based on the detected person, a feature relating to a pose of the person;
evaluating, based at least on the at least one feature, a safety state of the detected person; and
determining the safety state of the marine vessel based at least on the safety state of the person.

2. The method of claim 1, wherein detecting the at least one person comprises:
detecting the at least one person within a predetermined zoom-region of the at least one video frame.

3. The method of claim 2, wherein detecting the at least one person further comprises:
determining a bounding box associated with a location of the at least one person within the predetermined zoom-region; and
wherein determining the pose of the person comprises:
estimating the pose based on the bounding box.

4. The method of claim 1, wherein the method further comprises:
determining, based on the detected person, a feature relating to a protection equipment associated with the person.

5. The method of claim 1, wherein determining the feature relating to the protection equipment comprises:
localizing at least one region of interest on the detected person based on the determined pose of the person;
determining whether the at least one region of interest fulfills a corresponding safety requirement associated with the protection equipment.

6. The method of claim 5, wherein the at least one region of interest is a head of the at least one person; and
wherein the corresponding safety requirement is a helmet detection.

7. The method of claim 5, wherein the at one least region of interest is an upper-body part of the at least one person; and
wherein the corresponding safety requirement is a life-vest detection.

8. The method of claim 5, wherein the at least one region of interest is a full-body part of the at least one person; and
wherein the corresponding safety requirement is a uniform detection.

9. The method of claim 5, wherein evaluating the safety state of the detected person comprises:
setting the safety state of the detected person as not safe if the safety requirement is not fulfilled; or
setting the safety state of the detected person as safe if the safety requirement is fulfilled.

10. The method of claim 1, wherein the method further comprises:
determining a feature relating to a location of the detected person and/or pose within the videoframe.

11. The method of claim 10, wherein determining the feature relating to the location of the detected person and/or pose comprises:
extracting a feet-joint from the determined pose of the at least one person;
determining whether the feet-joint overlaps with a predetermined no-go region within the video frame.

12. The method of claim 11, wherein determining whether the feet-joint overlaps with the predetermined no-go region comprises:
determining coordinates of the feet joint within the video frame; and
determining whether the predetermined no-go region includes the determined coordinates of the feet joints.

13. The method of 11, wherein evaluating the safety of the detected person comprises:
setting the safety state of the detected person as not safe if the feet-joint overlaps with the predetermined no-go region; or
setting the safety state of the detected person as safe if the feet-joint does not overlap with the predetermined no-go region.

14. The method of claim 10, wherein determining the feature relating to the location of the person and/or the pose comprises:
determining whether the pose of the at least one person is a standing pose or falling pose; and
setting the safety state of the detected person as not safe if the pose is a falling pose; or
setting the safety state of the detected person as safe if the pose is a standing pose.

15. The method of claim 14, wherein determining whether the detected pose is a standing or falling pose comprises:
converting the pose into an abstraction of the pose;
determining a reference abstraction for the abstraction of the pose;
determining an angle between the reference abstraction and the abstraction of the pose; and
wherein the pose is a falling pose if the angle is larger than a predefined angle threshold; or
wherein the pose is a standing pose if the angle is smaller than or equal to the predefined angle threshold.

16. The method of claim 15, wherein converting the pose into the abstraction of the pose comprises:
determining a first principle segment based on a difference between a head-joint of the pose and a hips-joint of the pose;
determining a second principle segment based on a difference between the hips-joint of the pose and a feet-joint of the pose; and
wherein the first principle segment and the second principle segment represent the abstraction of the pose.

17. The method of claim 15, wherein determining the reference abstraction comprises:
splitting the video frame into a first plurality of subframes;
determining that a position of the pose is within one sub frame of the first plurality of subframes of the video frame;
selecting the reference abstraction associated with the one subframe.

18. The method of claim 15, wherein the reference abstraction comprises:
a third principle segment based on a difference between a head-joint of a reference pose and a hips-joint of the reference pose;
a fourth principle segment based on a difference between the hips-joint of the reference pose and a feet-joint of the reference pose; and
wherein the third principle segment and the fourth principle segment represent the reference abstraction.

19. The method of claim 10, wherein determining the feature relating to the location of the person and/or the pose comprises:
determining whether the pose of the at least one person is within a predetermined man-overboard region; and
setting the safety state of the detected person as not safe if the pose is within the predetermined man-overboard region; or
setting the safety state of the detected person as safe if the pose is not within the predetermined man-overboard region.

20. The method of claim 19, further comprising:
obtaining a second video frame being prior to the at least one video frame;
determining whether a person is detectable within a predetermined man-onboard region within the second video frame;
wherein setting the safety state of the detected person further depends on the person being detectable within the predetermined man-onboard region or not.

21. The method of claim 20, further comprising:
determining that the person is detectable within the predetermined man-onboard region within the second video frame;
determining that the pose of the detected person is within the predetermined man-overboard region within the one video frame;
extracting movement information at least between the second video frame and the one video frame using background subtraction;
determining whether the movement information relates to a fast movement or a slow movement;
wherein setting the safety state of the detected person further depends on the movement information relating to a fast movement or a slow movement.

22. The method of claim 21, wherein the movement information is associated with the person detected within the predetermined man-onboard region and the pose within the predetermined man-overboard region.

23. The method of claim 1, further comprising:
determining an operation state of the marine vessel based at least on the at least one video frame; and
wherein evaluating the safety state of the detected person is further based on the determined operation state of the marine vessel.

24. The method of claim 23, wherein determining the operation state comprises:
splitting the at least one video frame into a second plurality of subframes;
determining for each subframe of the second plurality of subframes of the video frame one operating condition classification resulting in a plurality of operating condition classifications; and
determining the operation state based on the plurality of operating condition classifications.

25. The method of claim 23, wherein the operation state indicates whether the marine vessel is moving or anchored.

26. The method of claim 24, wherein the operating condition classification indicates whether the subframe indicates sea or port.

27. The method of claim 1, further comprising:
issuing a safety notification based on the safety state of the marine vessel, wherein the safety state of the marine vessel indicates whether there is a safety issue on the marine vessel.

28. The method of claim 27, wherein issuing the safety notification is further based on temporal filtering.

29. The method of claim 1, wherein the at least one video frame is associated with one or more of vessel information, camera information, quality information, use-case information and/or operation information.

30. The method of claim 29, further comprising:
automatically extracting from the one video frame and/or from at least one previous video frame information associated with the one video frame and/or the at least one previous video frame; and
determining the vessel information, the camera information, the quality information, the use-case information and/or the operation information based on the extracted information.

31. The method of claim 29, wherein the predetermined zoom-region, the predetermined no-go region, the predetermined man-overboard region and/or the predetermined man-onboard region is based on at least one of the vessel information, camera information, quality information, use-case information and/or operation information.

32. The method of claim 1, further comprising:
displaying the safety state of the marine vessel as a point cloud comprising a plurality of points;
wherein each point of the plurality of points is associated with a safety issue on the marine vessel and/or a safety state of a person on the marine vessel.

33. A data-processing device comprising means for performing the method of claim 1.

34. A computer program comprising instructions, which when executed by a computer, causes the computer to perform the method of claim 1.

35. A marine vessel comprising at least one camera and the data-processing device of claim 33.
